(19) United States
(12) Patent Application Publication
(10) Pub. No.: US 2002/0029150 A1
(43) Pub. Date: Mar. 7, 2002

(54) Method for artwork and digital information management

(76) Inventors: Marian Vitale, Old Greenwich, CT (US); Janice Pleban-Bonis, Trumbull, CT (US); Peter Bertolini, Shelton, CT (US); Daniel P. Gizzo, New Fairfield, CT (US)

Correspondence Address: UNILEVER, PATENT DEPARTMENT, 45 RIVER ROAD, EDGEWATER, NJ, 07020, US

(21) Appl. No.: 09/909,158

(22) Filed: Jul. 19, 2001

Related U.S. Application Data
(60) Provisional application No. 60/229,464, filed on Sep. 1, 2000.

(51) Int. Cl. G06F 17/60

(52) U.S. Cl. 705/1; 705/22; 705/28

(57) ABSTRACT

An artwork and digital information management system is disclosed which faciliates the production, routing, releasing and archiving of packaging and design art work. In one embodiment the entire workflow takes place within the artwork digitial asset management system using both intranet and extranet servers and which allows replication between the two servers.

This application claims the benefit of U.S. provisional application no. 60/229,464, filed Sep. 1, 2000.

### TECHNICAL FIELD

The present invention relates generally to the processing of data by a computer system. More specifically, the present invention relates to a system for producing, routing, releasing and archiving packaging and design artwork.

### BACKGROUND OF THE INVENTION

Mechanicals for the production of product labels, or the like, may be created and modified by artists or other persons from artwork and other label information. This may be done manually or with the aid of artwork management systems comprising software, and one or more computers and printers which may optionally be networked.

Artwork management has been handled in a variety of ways prior to the availability of web based technology. Typically the information required for outside design or production studios to produce mechanical artwork is provided by the internal creative department to outside vendors via email, hand written notes or through telephone conversations or personal meetings. Once the studio has produced the mechanical art data files, they use various methods such as those involving removable media (disk, CD's) sent via courier, an electronic bulletin board service (BBS) or FTP (File Transfer Protocol) and Internet sites to provide the data files to the client. Routing the artwork internally for departmental sign off is usually a manual process whereby the artwork is created electronically and a color laser print is passed from department to department for a final sign off.

Another method is an electronic sign off process using an application such as Lotus Notes®, requiring each user to access the artwork and response document using e.g. Lotus Notes® Client. In this case, the approval or “sign off” must be done from the user's PC where the Lotus Notes® ID resides. File Maker Pro® is another database application frequently used for the routing of artwork. Again the user must have the File Maker Pro® application on her PC in order to access the artwork files and response documents. If changes to the artwork are required, and an outside vendor is again being used to make said changes; the information must then again be relayed to the studio via the above methods, and the new artwork provided to the client for re-routing. Once approved, releasing to purchasing vendors (separators or converters) can be done by various methods such as sending removal media via courier, sending an email with multiple file attachments, or electronically via BBS or to an FTP site. Archiving of approved documents is usually handled manually by physically filing a signed copy of the mechanical artwork and forwarding multiple copies to manufacturing plants for quality assurance and regulatory requirements, for example.

Logos and photographic images (“digital assets”), used commonly for promotion, sales, presentations and packaging, are frequently stored electronically by an outside vendor and distributed via floppy disk to users. Not all relevant images are scanned and are therefore unavailable as digital files. In some instances, unsecured websites are set up to allow download access, but there is often no authentication required and therefore no control over the download and potential usage of said images. Moreover photographic images are often available only in low resolution, JPG format. These formats may be acceptable for web use or e.g. PowerPoint® presentations, but are not conducive to high quality print production. In many cases, several images are available to outside users from several different sources providing little or no quality or version control of the digital assets. Furthermore, there are often no logo specifications readily available to users, allowing for unauthorized and unacceptable reproduction methods and treatment of company and brand logos etc. If high resolution images are stored in such hap-hazard way, usage rights can be violated easily if, e.g. a photograph or a model's image is reproduced in an unauthorized medium.

All of the above-described prior art methods for managing artwork and other digital assets have significant drawbacks notwithstanding the use of internet technology including, slow turnaround, lack of security, tedious download times and the frequent need for the services of a third party to archive and release files as required at additional expense and complexity. Furthermore, such prior art methods provide no consistency or control, and in fact often relinquish the control to outside vendors. Delays in the artwork management process can lead to costly rush and overtime charges by production vendors, missed ship-to-trade dates and the misuse of digital assets in general.

### SUMMARY OF THE INVENTION

An embodiment of the inventive artwork and digital asset management system facilitates handles the entire process from inception to archive and provides users with a convenient cross-platform interface to their web browser. In one embodiment of the invention, project and artwork forms are initiated internally by a project administrator. Internally is here defined as within a single company or similar organization or the like. All information for a mechanical is gathered on the artwork form assign to an internal or external production artist or agent, routed for approval or denial by reviewers or other agents, and rerouted to agents who alternatively, deny, release or archive the information.

This entire workflow takes place within the inventive artwork digital asset management system using both Intranet and extranet servers and in one embodiment, Lotus Domino® architecture or the like, which provides replication between the two servers. Email notifications, or the like, are sent automatically to agents responsible for production to alert them of new assignments, to other agents responsible for review alerting them of artwork that requires their approval, and to other agents responsible for production to alert them of new projects they have to produce. Inventive artwork files are routed as image files such as PDF (portable document format) files, or the like, created using an image creation application such as Adobe Acrobat®, or the like, to generally enable cross-platform viewing with e.g. a viewing application such as Adobe Acrobat Exchange® or the Reader® plug in, or the like.

In another embodiment, suitable communications application such as a “flash note” or integrated e-mail system enables agents to communicate with each other or with the project administrator without leaving the inventive system. Final, approved artwork data files are stored in the archive with e.g. the reviewing agents name and dates of approval in another embodiment of the invention. In a further embodiment, data can be gathered for reporting to e.g. pinpoint bottlenecks, to determine the most frequent reasons for artwork denial, and subsequent reroutes (copy changes, for example), or to gather data on average turnaround time for artwork in a specific business area, or the like.

### BRIEF DESCRIPTION OF THE DRAWINGS

The invention may best be understood by reference to the following description taken in conjunction with the accompanying drawings in which like figures represent like elements.

FIG. 1 shows diagrammatically the infrastructure of an embodiment of the inventive artwork and digital asset management system.

FIG. 2 depicts the workflow through an embodiment of the inventive artwork management system.

FIG. 2A depicts in greater detail the workflow through the inventive system depicted in FIG. 2.

FIG. 2B depicts in greater detail the workflow through the review system depicted in FIG. 2.

FIG. 3 shows diagrammatically several useful application databases in an embodiment of the inventive artwork digital access management system

### DETAILED DESCRIPTION OF THE INVENTION

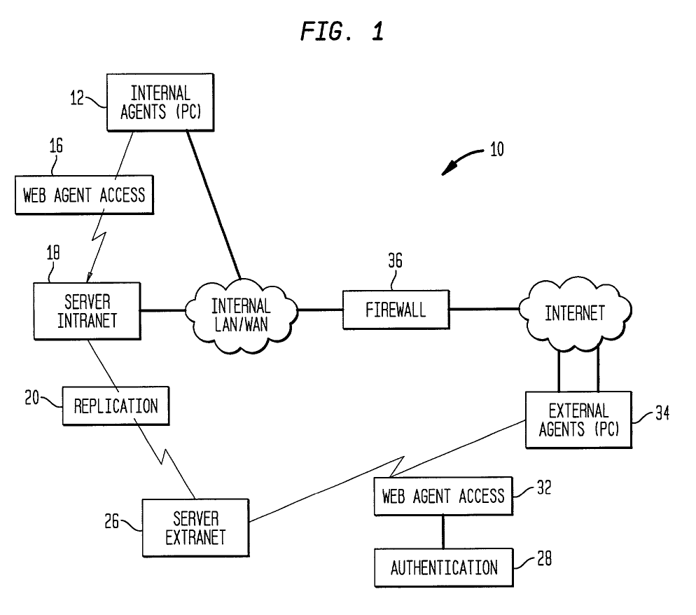

FIG. 1 shows diagrammatically the infrastructure of an embodiment of the inventive artwork and digital asset management system 10. Internal agents 12 access via a PC, MAC, or similar device the Internet server 18 across network 16 which is typically a LAN/WAN. All data files uploaded by internal agents 12 to Intranet server 18 are automatically replicated using replication application 20 accessing extranet server 26. These data files may include a database of logos and design elements in graphic files, name and address books of agents, master pick list values which control access to the data among different agents, product and regulatory information, archives of product artwork and packaging configurations and the like. External agents 34 may access the system 10 over network 32 and the extranet server 26 after authenticating 28 they're right to do so. Network 32 can be by Internet access via dialup, ISDN, DSL, T1, Fiber Optics or the like. Control device or Firewall 36 isolates the Internet server 18 from external agents 34.

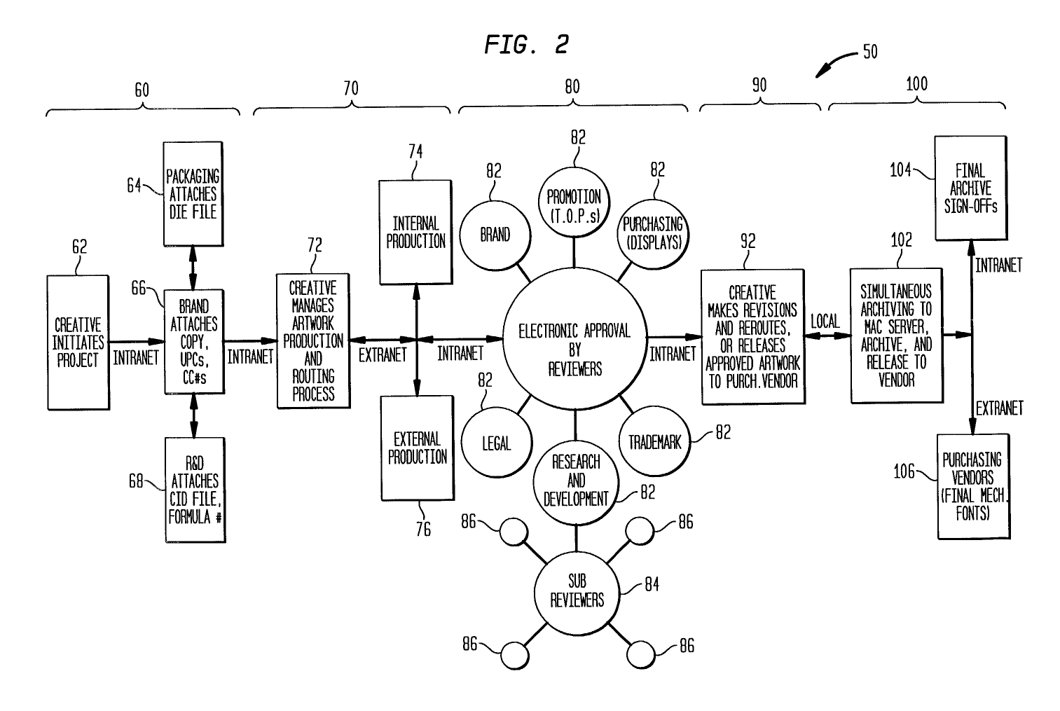

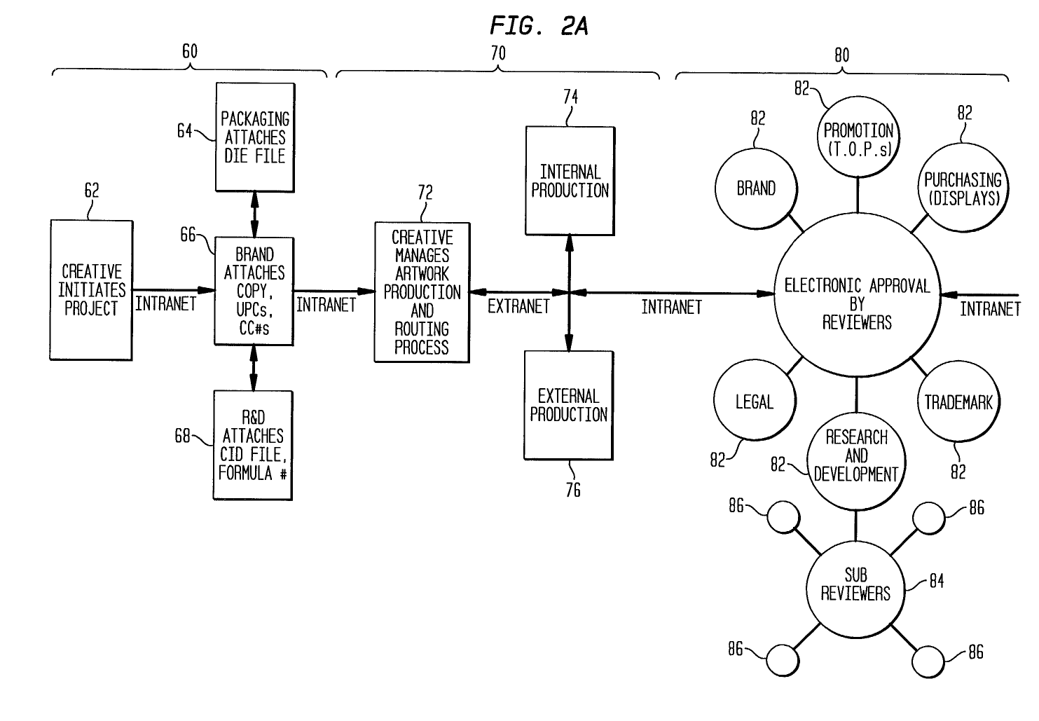

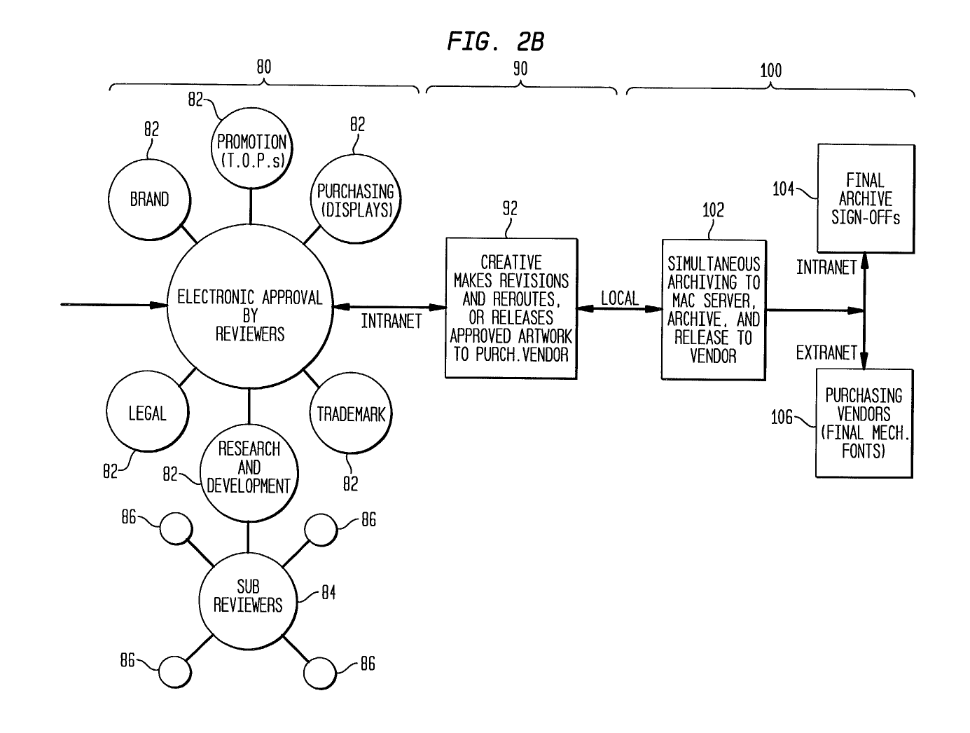

FIG. 2, depicts the workflow through an embodiment of the inventive artwork management system 50 divided into an information collection system 60, a coordinator system 70, a review system 80, an approval system 90, and a production system 100.

FIG. 2A depicts in greater detail the workflow through the inventive system 50 with regard to information collection system 60, coordination system 70, and review system 80.

In this embodiment, the creative department initiates an artwork project 62 and uploads it to intranet server 18 via LAN/WAN 20 alerting agents in other internal departments e.g. 64, 66 and 68 to provide required artwork related information such as packaging 64, design 66, code number 66, and formulation information 68 and the like. Next in the coordination system 70, creative department 72 reviews the compiled artwork information for accuracy and completeness and upon approval routes the artwork information to either an internal production agent 74 via intranet server 18 or an external production agent 72 via the extranet server 26 or the like, so as to produce the requested artwork mechanical.

In review system 80, the completed mechanical is reviewed using the intranet server 18 by various internal reviewing agents 82 who may approve the mechanical as is or suggest changes. This input becomes a part of the artwork mechanical data file and is accessible to all authorized agents. Authorized sub reviewing agents 84 and 86 within the department of a reviewing agent 82 may also suggest changes. Typically, internal reviewing agents may have such business functions as research and development, trademark, purchasing, marketing, promotion, brand management, legal affairs, and the like.

FIG. 2B depicts in greater detail the workflow through the review system 80, approval 90 and production 100 systems of the inventive artwork management system 50. The creative department reviews 92, the input from the reviewing agents 82, revises the artwork mechanical or contacts the reviewing agent for clarification as the case may be until agreement is reached about the mechanical. Upon final approval, the creative department 92 simultaneously archives the approved mechanical 104 in Intranet server 18 and releases it to at least one external agent for production of the package 106 via extranet server 26.

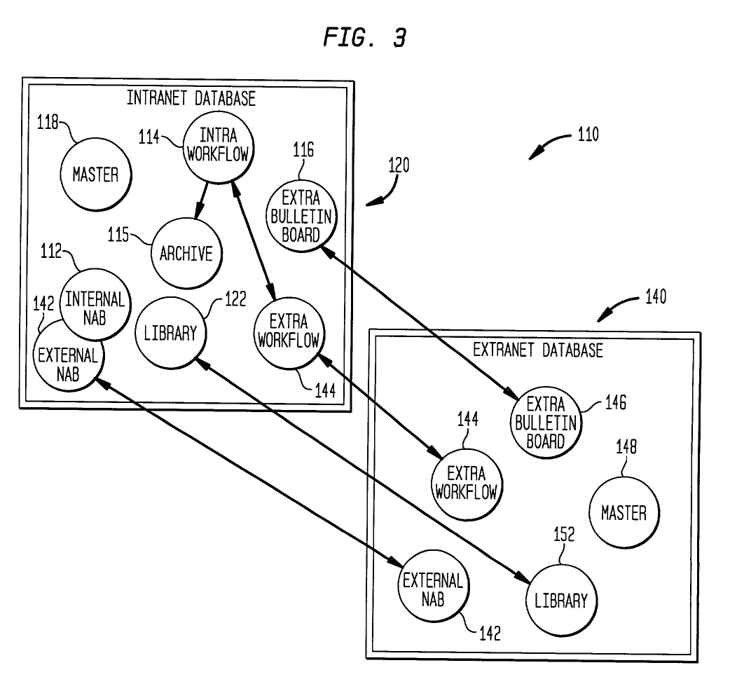

Referring to FIG. 3, the figure shows diagrammatically several useful application databases 110 in an embodiment of the inventive artwork digital access management system. These databases typically reside in either Intranet server 18 as Intranet databases 120 or reside in extranet server 26 as extranet databases 140. Internal name and address book database 112 is replicated as an external name and address book database 142 to extranet server 26. The name and address book databases serve to provide a list of authorized users, administrators, and their business roles for applications security purposes. Intranet workflow database 114 in intranet server 18, which comprises the tasks of creating, assigning business roles and reviewing roles, is frequently or preferably continuously archived as archive database 115. Archive database 115 resides in Intranet server 18 and is replicated as extranet workflow database 144 in extranet server 26. The work flow databases 114, 144 contain work input information from internal agents such as administrators, art coordinators, art directors, reviewers, sub-reviewers, designers, and browsers; and from external agents such as designers, production houses, and purchasing vendors, and the like. Extranet bulletin board application 116 residing in Intranet server 18 is replicated as extranet bulletin board 146 in extranet server 26. Extranet bulletin board databases 116, 146 contain information regarding external communications and deliverables, and the like. Master pick list values databases 118, 148 typically reside in Intranet server 18 and the extranet server 26.

Library database 122 containing an artwork library of product images, logos and the like, resides in intranet server 18 and is replicated as library database 152 in extranet server 26.

The inventive artwork and digital asset management system provides a method of managing the artwork process using web based technology, intranet and extranet servers in conjunction with Lotus Domino® Database Architecture, or the like. The inventive method provides a linear, controlled way for an agent to produce mechanical artwork (internally or externally), routed internally for approvals, make changes, reroute, and release approved artwork for print production, and archive final approved artwork for record-keeping purposes. Software applications required for the user in an embodiment of the invention includes a web browser or the like and, for example, Acrobat® plug-in or a full version of Acrobat Exchange® or the like if cropping and printing of the artwork file is required. In another embodiment of the invention, agents who are reviewers are provided agent identification codes or id's and passwords to ensure that the proper signatures or approvals are registered for each session. These agents can access this system via the Intranet or as external agents via the Internet given the proper authentication set up or the like. This allows the agents to review their assignments regardless of their proximity to their own PC.

In another embodiment, the inventive method provides, for example, reporting capabilities, ongoing status reports, at-a-glance views of projects, all artwork within a project and the status of those data files such as, reviewed, released, etc. See e.g., screen shots of online forms, FIG. 4B. The inventive method provides agents in another embodiment with an application such as custom ruler plug in or the like whereby they can measure and compare particular aspects of the artwork being viewed or the like. Agents who are not reviewers can use browser entry access from an introductory screen display to view the status of artwork currently routing within the system, and view the actual PDF or graphic file, but cannot approve or deny the artwork.

In another embodiment of the inventive artwork and digital management system is a master database 118, 148. A project administrator or other user may create a viewer list in the master database 118, 148. Organized, for example, by category, brand, sub-brand, or product, etc. These names will typically appear as a default reviewer list when a project is created with these parameters. These category names can be changed, added, and deleted at any time. As before users are usually assigned ID's and passwords and enter into groups (which have variable permissions) in the Lotus Notes® Database or the like. The inventive system is able to organize reviewers based on categories such as the product name of the specific project or the like. See e.g. online screen shots, FIGS. 14-15.

The inventive system facilitates the creation of pre-mechanical artwork in another embodiment. In this embodiment typically the project administrator or user signs into the system by going to the inventive system initial display (or homepage), selecting projects by brand or other desired category, and signing in with an administrator password to allow full administrator permission. Next a new project form and related artwork forms are created. See e.g. online screen shots, FIG. 4A. Forms specific to each mechanical may be created and made available for input from the reviewers or other users, so that creative personnel can produce additional mechanicals. Users who are reviewers can now sign in to the system, go to for example, “artwork by brand” category, find the artwork that applies to a specific project and open the form, see FIGS. 4B-4C. The user will typically edit and or type information into open fields or attach files containing copy, ingredients, etc. which will appear in the final mechanical. If a certain file applies to all artwork within a project, the user can edit the project form to show this relationship. The user can also attach a file to the form which will applied to all related artworks if applicable.

Once all the information necessary to produce a mechanical has been attached or inputted in the system, a designated user can rename the form as “pre-mechanical complete” which indicates that the artwork is now ready to be assigned to an internal or external designer/production artist, see FIGS. 4D-5. In this embodiment, the project administrator can either open the project form and select the artwork that is ready to be assigned or can go into each artwork form and assign a designer at that point. The designer or user will typically receive an email notification that a new assignment has been put into their secure system mailbox, see FIG. 6. Once the artwork has been sent in this manner, the status changes usually from “pre-mechanical complete” to either “internal new” or “external new” or the like.

In an embodiment of the inventive system known as internal/external work in progress, the designer or other user accesses the artwork digital asset management system extranet site via the Internet and logs in using a user ID and password or the like, see FIGS. 6-11. Extranet security can be handled by one of many available authentication programs or protocols. For example, Verisign® authentication, or the like. In this embodiment the designer typically sees only the projects artwork assigned to herself. New assignments are typically labeled “new assignments” but once a designer opens the project or artwork document, the status changes to “internal or external work in progress” or the like. In this embodiment, the designer typically downloads the attachments to use in the mechanical production, and when the artwork is completed a PDF or other graphics file is attached to that same artwork form. When the designer attaches the PDF file or other graphics file, the original attachments are typically deleted. In addition, in this embodiment after the artwork is completed the artwork status is typically changed to “pending send to client”. When each PDF or other graphics file has been attached to each artwork form within a project the designer opens the project form and attaches the “live” artwork files, fonts, and places images in an archive file, for example, a Stuffit® file or the like. This process, when completed, changes the artwork status to “internal or external complete”, see FIG. 12.

In an embodiment of the inventive artwork and digital asset management system, everything that occurs on the extranet is replicated on the artwork in the digital asset management system Intranet. The project administrator typically tracks the status of all artwork that has been assigned to a designer. Once the artwork has achieved the status of “internal/external completion”, it is ready for routing, see FIG. 13.

In this embodiment of the invention, the project administrator typically opens the project form and selects a “to route” status, see FIG. 15. A routing form appears with the project name, category and subcategory information and the like and the checklist of artwork related to that project, which are ready to route, see FIG. 15. In this embodiment, artwork to be routed is checked and the default reviewer's names appear in a list with yes/no indications or a similar designation. “Yes” is chosen for any reviewer who should approve the artwork. If a certain department needs to approve, but the default project name is not correct or unavailable, another name can be chosen from a pull down picklist, or the like. In this embodiment, this name will override the default.

After the decision “to route” is selected, the artworks are moved to “under review” status, see FIG. 15. At this point in this embodiment to the invention, an email notification or the like is sent to all designated reviewers alerting them of artwork that is ready for approval. The reviewers then typically access the inventive artwork and digital asset management system using their web browser, user id and password or the like. The designated reviewers are then typically presented with a list of artwork designated as for example, “still waiting”, “pending” or the like, see FIG. 16. The designated reviewers will typically then select a pending artwork file which will in another embodiment of the invention bring up a response document which the reviewer can view the PDF or graphics file or the like. In this embodiment the action to select the file launches the artwork file using Adobe Acrobat Exchange® or the like and the custom built ruler plug-in, to allow for measurement type and die drawings or the like. If the artwork is acceptable, the reviewer goes back to the response document and selects an “approval” designation. If there are further artwork files to view, the reviewer can select them in turn and approve or disapprove them individually or collectively. This action typically stores the response document and presents the next response document requiring review. In this embodiment of the invention, if the artwork requires changes, the reviewer will select a “denied” status or the like, select a specific denial reason from typically a list of choices, save the document and either close it or go to the next artwork document requiring review. In this embodiment the reviewer can go back and change her response as long as the artwork is still in the “under review” status designation, or the like, see FIG. 17.

After all reviewers have approved artwork, the administrator may select the “release” status and attach approved artwork files to the project form to send to the vendor via the extranet or the like, see FIG. 19. In this embodiment the vendor name may be selected from a pull down or similar menu and “artwork to be released” is selected from a picklist or similar menu (in case there are artwork files going to different vendors). The artwork files are then transmitted to their intended destination. At this point artwork files and PDF graphic files typically go to the vendors extranet mailbox or the like and the PDF or graphic files with electronic sign-offs go to the inventive system's archive or the like, see FIGS. 20 - 23.

In another embodiment of the invention, if the artwork has been “denied” for whatever reason, the administrator assigns the “denied” artwork to an internal designer. The Internal designer references the information concerning the denial and typically makes changes to the artwork, creating a new PDF or graphics file, and attaching to the new file project file using the inventive system's extranet mailbox or the like. The administrator may reroute the artwork which typically will go to only to the reviewers who denied it the first round. Under the “working data” or a similar field the reviewers can see the denial comments from the previous round. Reviewers who approved the first round can typically still see and track the progress of artwork that is routing and view the denial comments, see FIG. 18.

In another embodiment of the invention, all approved artwork is stored with e.g. electronic signatures and date stamping, or the like, in an archive or image library which is accessible to authorized users, see FIGS. 24 - 25. Such an image library may be used for quality assurance, meeting governmental requirements, or for reference purposes. Users may typically retrieve information and images from the library by product brand, code number, date, or by a variety of other methods.

The foregoing description and examples illustrate selected embodiments of the present invention. In light thereof variations and modifications will be suggested to one skilled in the art, all of which are within the scope and spirit of this invention.

In the claims:

1. A computer implemented artwork management system for distributing and controlling artwork in a computer system, comprising:
an information collection system for compiling pre-mechanical specification information according to a predefined procedure from a plurality of agents to create a data file;
a coordination system connected to said information collection system for creating a mechanical artwork design data file incorporating said specification information and identifying an internal or an external agent for creating said mechanical artwork, reviewing said mechanical artwork, and routing said mechanical artwork according to a predefined procedure;
a reviewing system connected to said coordination system for compiling, exchanging and reviewing information from a plurality of agents concerning said mechanical artwork data file according to a predefined procedure;
an approval system connected to said organization system for evaluating said critical information contained in said data file, requesting changes to said mechanical artwork, and approving said mechanical artwork for production according to a predefined procedure;
a production system connected to said review system for assigning approved mechanical artwork by transmitting said data file to at least one external agent for production;
wherein said plurality of internal agents communicate using an internal data transmission and computer system and communicate with said at least one external agent using an external data transmission and computer system which is separated from said internal computer system by a control device; and
wherein all internal data files uploaded to said external computer by said internal agents are automatically replicated on said external computer system as external data files which duplicate said internal data files.

2. The computer implemented artwork management system of claim 1 wherein said information system has an information collection facility and a project creation facility.

3. The computer implemented artwork management system of claim 2 wherein said information collection facility includes information selected from the group consisting of product ingredients, packaging components, regulatory information, and product design elements.

4. The computer implemented artwork management system of claim 1 wherein said coordination system includes functions selected from the group consisting of indicating when information collection is complete, indicating when mechanical production is complete, and exchanging work status information with agents.

5. The computer implemented artwork management system of claim 1 wherein said review system includes functions selected from the group consisting of polling agents for approval, denial, or comments; authenticating agents' input using electronic signatures, exchanging information between agents, and allowing sub-agents to submit comments.

6. The computer implemented artwork management system of claim 1 wherein said production system includes functions selected from the group consisting of indicating when the external production facility has received their assignment, and archiving said data file in said internal computer system.

7. The computer implemented artwork management system of claim 1 wherein said internal data files include one or more databases selected from the group consisting of logos, design elements, names and addresses of agents, master pick list values, product and regulatory information, archives of product artwork and packaging configurations and workflow information.

8. The computer implemented artwork management system of claim 1 wherein transmission of data between internal and external agents is implemented by web browser software and the Internet.

9. The computer implemented artwork management system of claim 1 wherein authentication of identity of internal and external agents is required for access to said management system.

10. The computer implemented artwork management system of claim 1 wherein said external data files include one or more databases selected from the group consisting of names and addresses of agents, master pick list values, and workflow information.

11. The computer implemented artwork management system of claim 1 wherein internal agents include agents with approval authority and agents without approval authority.

12. The computer implemented artwork management system of claim 1 wherein the list of agents with access to any data file residing in said information, organization, and review systems can be varied for different artwork projects.

13. The computer implemented artwork management system of claim 1 wherein said data file has a status label indicating its review status among a predefined set of agents.

14. The computer implemented artwork management system of claim 1 wherein said data file includes at least one project information text file and at least one graphics file.

15. The computer implemented artwork management system of claim 1 wherein any of said authorized agents may see the review status of said mechanical at any time.

16. A method for distributing and controlling artwork in a computer system, comprising:
collecting pre-mechanical specification information according to a predefined procedure from a plurality of agents to create a data file;
creating an artwork production scheme incorporating said pre-mechanical specification information
identifying an internal or an external agent for producing mechanical artwork;
approving said mechanical artwork according to a predefined procedure;
transmitting said mechanical artwork to a production facility according to a predefined procedure;
compiling critical information between a plurality of internal and external agents concerning said mechanical artwork according to a predefined procedure;
exchanging critical information between a plurality of internal and external agents concerning said mechanical artwork according to a predefined procedure;
wherein said plurality of internal agents communicate use an internal data transmission and computer system and communicate with said at least one external agent using an external data transmission and computer system which is separated from said internal computer system by a control device; and
wherein all mechanical artwork information contained in internal data files uploaded to said external computer by said internal agents are automatically replicated on said external computer system as external data files which duplicate said internal data files.
